(19) United States
(12) Patent Application Publication
(10) Pub. No.: US 2009/0183030 A1
(43) Pub. Date: Jul. 16, 2009

(54) EPISODIC CAUSE ANALYSIS

(76) Inventors: Bob Bethke, Fort Collins, CO (US); Srikanth Natarajan, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/250,887

(22) Filed: Oct. 14, 2008

Related U.S. Application Data
(60) Provisional application No. 61/044,169, filed on Apr. 11, 2008.
(60) Provisional application No. 61/011,102, filed on Jan. 14, 2008.
(60) Provisional application No. 61/011,103, filed on Jan. 14, 2008.

(51) Int. Cl. G06F 11/07

(52) U.S. Cl. 714/37; 714/E11.024

(57) ABSTRACT

Managing a root cause analysis and outputting an identified root cause, for use in a system comprising a plurality of inter-related elements wherein at least some of the elements experience one or more anomalous states, comprising receiving initial indicators of system element states symptomatic of anomalous element operation, selecting an episode expiration time based on the received initial indicators, receiving additional such indicators, correlating the indicators received prior to the episode expiration time based on pre-defined relationships between the system elements, generating possible causes of the anomalous element states consistent with the received indicators and the pre-defined relationships, asserting possible causes as actual causes, identifying an actual cause as a root cause, and outputting the root cause.

This application is related to and cross references the following co-owned U.S. Patent Applications: Ser. No. 61/011,169 (Attorney Docket No. 200701781-1/411478) entitled ROOT CAUSE ANALYSIS IN A SYSTEM HAVING A PLURALITY OF INTER-RELATED ELEMENTS; Ser. No. 61/011,102 (Attorney Docket No. 200701782-1/411479) entitled ENGINE FOR PERFORMING ROOT CAUSE AND EFFECT ANALYSIS; and Ser. No. 61/011,103 (Attorney Docket No. 200701797-1/411480) entitled COMPILATION OF CAUSAL RULES INTO CONTINUATIONS.

### BACKGROUND

The disclosed methods relate generally to analyzing and determining the root cause of anomalous behavior of elements of an interconnected system, and in particular with the generation and management of analysis artifacts in such root cause analysis.

Troubleshooting a problem in a complex system comprising interconnected elements can be difficult. In computing, for example, a computer application that receives data from a data network may be operating slowly. There may be many different possible causes of such slowness, and discovering the root cause of the slowness can be difficult. Many other types of interconnected systems exist in many different fields or domains, in which it can be similarly difficult to identify the root cause of a problem.

Typically an analyst, such as a system engineer or other expert, may be called upon to troubleshoot a complex system exhibiting a problem. However, the troubleshooting process becomes increasingly intractable and time consuming as the systems analyzed become more complex, especially if the sources of reported information are imperfect or limited, or the various elements of an inter-related system exist in different system levels, or have different scope, or the like.

Automated tools exist to aid the analyst in troubleshooting a complex system exhibiting symptoms that indicate a problem exists. Those tools generally use methods that filter symptom indicators according to similar symptoms, or correlate symptoms with known causes, or learn patterns of symptoms and correlate them with predetermined causes, or use a code book containing a set of rules for determining a root cause of the symptoms. However, if a symptom experienced by a particular element has as its root cause a problem that exists on another, perhaps far removed and distantly related element, those approaches may not be sufficient to discover the root cause of the symptom. Furthermore, the same root cause may result in many different symptoms in many different inter-related elements of the system, some of which symptoms may not have been anticipated or even experienced before. Using existing practices, it may be difficult or impossible to quickly and correctly determine the root cause of one or more symptoms.

In addition, for organizational or analytical convenience, different system elements may be regarded as belonging to different “planes,” each plane representing some characteristic that the elements of that plane have in common. For example, for a computer application experiencing slowness, system elements might be divided into a network plane comprising network elements such as routers, switches, and communication links; a computing plane comprising computing elements such as servers and clusters of servers; and an application plane comprising databases, served applications such as web applications, and the like. Analyzing a system can thus be even more difficult if inter-related elements experiencing symptoms exist in different planes of the system.

One example of a complex system in which such analysis can be advantageous is a large enterprise network. Such large networks are typically managed using some type of management application. The primary function of any enterprise management application is to actively monitor and provide fault and performance information to administrators and operators when a problem occurs. To do this, management systems will typically receive indicators of anomalous behavior of monitored objects such as system elements, and create “incidents” associated with the anomalous behavior of monitored objects, and also change the status of monitored objects to indicate a problem. A management application may analyze those incidents and status changes to generate hypotheses regarding possible causes of the problem. The incidents, status changes, and hypotheses are referred to herein as artifacts of the analysis.

In a large interconnected system, a problem in even a single element of the system can cause anomalous behavior on potentially many other related system elements, as the effects of the problem on the related elements propagate to other elements to which they themselves are related. A potentially large number of analysis artifacts can thus be generated in analyzing the root cause of those effects. In addition, in a system wherein the elements react quickly to system changes, such as an enterprise network, the effects of a problem can propagate very quickly, resulting in an avalanche of artifacts.

What is needed is a way to manage the analysis artifacts so that they do not overwhelm a system analyst, and so that the root cause is identified quickly and clearly.

### SUMMARY

Managing a root cause analysis and outputting an identified root cause, for use in a system comprising a plurality of inter-related elements wherein at least some of the elements experience one or more anomalous states, comprising receiving initial indicators of system element states symptomatic of anomalous element operation, selecting an episode expiration time based on the received initial indicators, receiving additional such indicators, correlating the indicators received prior to the episode expiration time based on pre-defined relationships between the system elements, generating possible causes of the anomalous element states consistent with the received indicators and the pre-defined relationships, asserting possible causes as actual causes, identifying an actual cause as a root cause, and outputting the root cause.

It is to be understood that both the foregoing general description and the following detailed description are exemplary and explanatory and are intended to provide further explanation of the claims.

### BRIEF DESCRIPTION OF THE DRAWINGS

The accompanying drawings, which are included to provide a further understanding of the disclosed systems and methods and are incorporated in and constitute a part of this specification, illustrate exemplary embodiments of the systems and methods and together with the description serve to explain the principles of the systems and methods.

In the drawings:

FIG. 1 shows a diagram of an exemplary networked computer system wherein various system elements exist in different planes.

FIG. 2 is a block diagram of an exemplary causal engine architecture.

FIG. 3 shows a causal graph indicating relationships between various system elements of the system of FIG. 1, experiencing symptoms indicative of a problem on the system.

FIG. 4 shows a flow diagram illustrating a method of managing artifacts of a root cause analysis.

### DETAILED DESCRIPTION

As used herein, the term “anomalous element operation” is used to denote that the state of some system element, such as a managed entity, has changed from a non-problematic state to a state symptomatic of a problem.

The term “causal rule” is used to denote a rule relating a condition on a system element to another condition, on the same or another system element. For example, a rule might indicate that an interface of a system element becoming inoperable (“going down”) can cause a related effect, such a Simple Network Management Protocol (SNMP) link going down, or an Internet Protocol (IP) address not responding to an Internet Control Message Protocol (ICMP) ping. Conditions can be related causally using causal rules.

The term “continuation” is used to indicate one or more additional steps to perform in an analysis, and/or program instructions to execute, upon the completion of a determined operation in an analysis and/or execution of a program routine, respectively.

An especially capable approach to troubleshooting problems in complex systems of inter-related elements involves the use of a continuation passing style of analysis. This may be achieved, for example, as described in co-owned U.S. patent application Ser. No. 11/XXX,XXX.

The term “continuation passing style” (CPS) is used herein to denote a style of analysis or programming in which a first object, operation, or routine is provided with an explicit “continuation” step that is invoked by the first object as the next object, operation, or routine in the analysis, to which the invoking object can pass its own results. The next object, operation, or routine likewise can be provided with a continuation step to a further object, operation, or routine to which it can pass its own results. The further object can be provided with a continuation step to a still further object, and so on. The continuation steps may be invoked only if certain conditions are met. The analysis can continue until an object, operation, or routine is reached that is not provided with a continuation step, or until the conditions for invoking the next continuation step are not met.

For example, when a computer program routine calls a subroutine, the routine may explicitly pass to the subroutine, or the subroutine may already include, a continuation function directing the subroutine to a next step when the subroutine finishes. The continuation may be executed only if certain predetermined conditions exist.

The consistent use of continuations when control of a process or program transfers from one step of an analysis or program to another, by making explicit the flow of control within the overall analysis or program, can assist the analyst or programmer both in defining and in tracking the flow of control. Continuations can be used in troubleshooting to trace symptoms to their root cause, or to help determine what additional information may be needed to identify a root cause among a plurality of possibilities.

As noted previously, in a large interconnected system, a problem in even a single element of the system can cause anomalous behavior on potentially many other related system elements, as the effect of the problem on the related elements propagates to other elements to which they themselves are related. A potentially large number of analysis artifacts can thus be generated in analyzing the root cause of these effects. In addition, in a system wherein the elements react quickly to system changes, such as an enterprise network, the effects of a problem can propagate very quickly, resulting in an avalanche of artifacts.

The herein described methods may be used in analyzing the root cause of symptoms indicative of problems in a complex system having inter-related elements. Analysis artifacts can be generated that represent symptoms indicative of a problem on the system, such as an anomalous state in one or more system elements. The artifacts can be generated when indicators of symptoms on system elements are received, such as from a management application that monitors the state of the system elements. The elements, and conditions on the elements, can be related by causal rules. The artifacts and causal rules can be used in a root cause analysis using an analytical engine. The engine can identify and output a root cause consistent with the artifacts and causal rules. The artifacts can be managed, for example, to hide their complexity, to illustrate the extent of the effects of the problem on the system, and/or to indicate the root cause of the problem. The engine can be adapted to analyze a system of arbitrary complexity in any domain, using system element model types, condition/conclusion declarations, and rule specifications appropriate to that system and domain.

For example, an illustrative causal language model can represent system elements using instances of “model types” that represent system elements of various types. The language can support at least three operators that apply to conditions, referred to herein as “causes,” “propagates,” and “triggers.” The “causes” operator can relate conditions causally. The “propagates” operator can be used to propagate one or more conditions on a model type instance to another condition on a different model type instance. This can be useful, for example, for propagating status type conditions to container objects, based on the state of the contained objects. For example, for a server (a container object) containing a network card (a contained object), a failure of the card can cause an inactive status to propagate to the server.

The “triggers” operator can be used to execute an operation on a model type instance based on the existence of an anomalous condition. This can be useful, for example, to direct particular management processes to perform specified actions based on received indicators of anomalous conditions. For example, when a linkdown trap is detected on an interface of a network device, polling the interface on the network device can be triggered, to determine the status of the interface.

In one illustrative analysis model, anomalous conditions can be observed or derived. In the context of a network management application, the observed conditions can represent changes in the states of managed entities. In an illustrative network management application, for example, the utilization of a managed interface exceeding a predetermined threshold may be an observed anomalous condition. In the illustrative model, an anomalous condition can be defined by attributes such as condition name, a managed entity type to which the condition applies, concrete versus derived, and severity. Illustratively, a model type can support a set of methods that can be used to qualify and relate conditions.

The illustrative analysis model can include a root cause analysis engine for analyzing a complex system comprising inter-related elements experiencing problematic symptoms. The engine can be extended to enable analysis of a system of arbitrary complexity, and can be used to analyze a system in any modeled domain. The system may be modeled, for example, by organizing the system elements into planes, such as in accordance with characteristics the various elements have in common. Using the analysis engine, root cause analyses can be done over a plurality of planes in any modeled domain.

For example, in the domain of computer networking, an illustrative complex computer network system comprising many elements can be modeled as having three planes comprising the elements of the system. An application plane can comprise applications such as a web application, associated web server software, associated databases, and the like. A system plane can comprise devices within servers, servers, server clusters comprising servers, server farms comprising servers, and the like. A network plane can comprise elements such as routers, switches, communication links, interfaces, and the like. An example in a different domain may be a complex power distribution system comprising planes that exist at different system voltages. Many other examples of complex systems can be found in many different domains, such as biological systems, environmental systems, economic systems, etc.

What is common in analyzing such complex systems are the ways in which system elements are related, and the relationships between problematic symptoms of the elements. What is different is the underlying domain, which may include various planes of the domain model. The analysis engine can operate on any type of system using appropriately defined system element model types, condition/conclusion declarations, and rule specifications; and it can be used to analyze a system of arbitrary complexity because it can execute the specified rules in a generic, extensible way. The engine can thus be adapted to different domains in a straightforward manner by providing the appropriate underlying domain model abstractions.

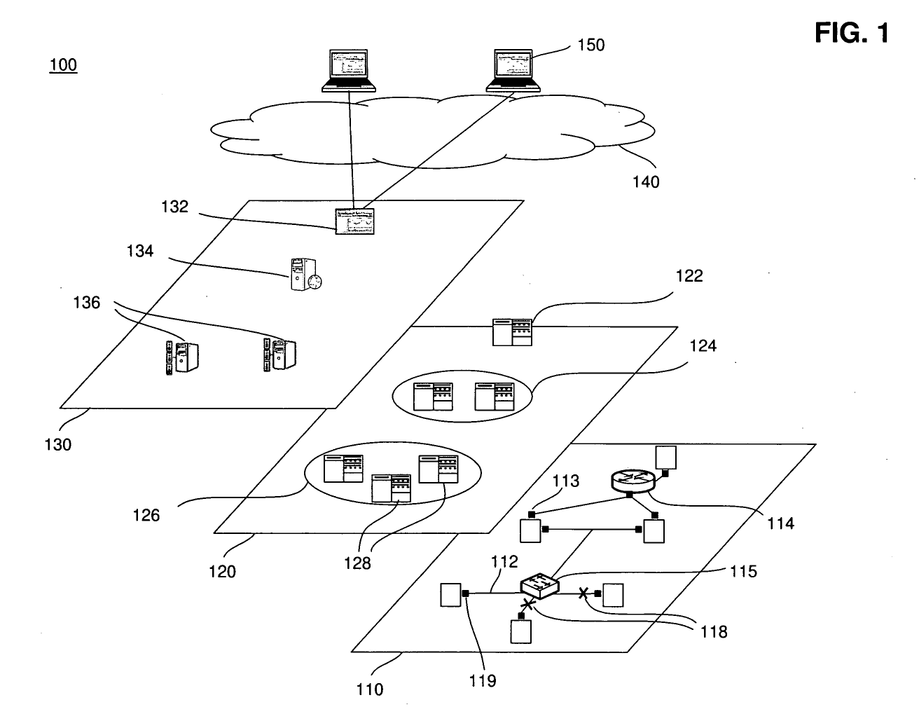

For instance, using the illustrative networked computer system having a management application discussed previously, root cause analysis can be accomplished even though the abstracted system elements can exist in various planes. FIG. 1 illustrates an example of such a system. In FIG. 1, an illustrative networked computer system is shown (100). The computer system can comprise a network plane (110), a system plane (120), and an application plane (130). The system is communicatively connected via a network cloud (140), such as the Internet, to user computers (150). Illustratively, the network plane can comprise elements such as Ethernet links (112), interfaces (113), routers (114), switches (115), and the like. The system plane can comprise elements such as servers (122), server clusters (124) comprising servers, and server farms (126) comprising servers. The application plane can comprise elements such as hosted web applications (132), and associated web server applications (134) and databases (136). Problems experienced on one plane can cause problematic symptoms on elements of another plane. For example, if two Ethernet links fail (118), that failure can render two servers of a server farm inaccessible (128) by disconnecting them from the rest of the system. The result may be slowness in the performance of a database, depended on by an application server serving a web application displayed on user computers (150), causing the user to experience a slow response in the web application. As a result, the server farm may be put at risk of failure.

In an exemplary root cause analysis platform wherein elements of a monitored analyzed system, and conditions on those elements, are causally related and modeled, an analysis engine can determine the cause of one or more symptoms indicative of a problem on the analyzed system. As described previously, an illustrative computer programming language adapted to use a continuation passing style (CPS) of programming can be used to develop such a root cause analysis platform, which can be used in conjunction with a management application for managing the system. Such a computer language can be used to model the elements of the monitored system, define anomalous conditions of the elements, and to define the causal relationships among and between elements and conditions.

Enterprise management applications typically comprise monitoring functionality, for monitoring or determining the status of elements on the monitored system. The monitoring function of a management application can also typically detect relevant state changes on elements, which can be represented by concrete anomalous conditions, as described previously. The exemplary analysis engine can receive as inputs concrete conditions generated, for example, using information provided by the management system, and can determine which of the defined rules, including causal rules, to apply to the received conditions. For each candidate causal rule a “hypothesis” regarding the cause of the received condition can be generated. If all the conditions of the hypothesis are met, then the hypothesis can be asserted as a conclusion. The conclusion can then be asserted as a new condition, and the engine can then determine which of the defined rules to apply to the new condition, as before. Advantageously, each condition can be bound to an instance of a modeled element in the underlying domain model. This process can be repeated until all conditions are satisfied, and a final root cause is determined.

In many root cause analysis situations, it may be helpful to solicit additional symptoms in order to progress in the analysis or to disambiguate a plurality of possible causes of a condition. To facilitate this, the illustrative causal language can support “triggering” an action for the purpose of generating additional information, such as to reveal additional anomalous conditions. For example, if an enterprise network node is down, the only symptom that may be initially reported is that the node is not responding to SNMP. Because this symptom can arise due to more than one root cause, it may be helpful to trigger one or more additional actions to generate additional information to discover additional symptoms. For example, triggers can be generated to poll the node's neighbors, in order to determine how the neighbors respond, and to disambiguate whether the node is down, or whether only the agent process is down. After being disambiguated, a conclusion can be asserted as to the cause of that symptom.

Illustratively, when the conclusion is asserted, it can be posted to a blackboard. In an exemplary embodiment, the blackboard can comprise a shared repository of partial solutions managed by the analysis engine, the engine controlling the flow of problem-solving activity. The blackboard can also create functional artifacts needed to determine the root cause, as will be described. This may include generating incidents such as triggering polling events, or setting attributes on underlying instances of modeled elements.

In an illustrative analysis platform, a parser for parsing program statements, and a module loader for loading program modules that perform various analysis functions, can provide a mechanism for configuring the analysis engine. The previously described model type definitions, condition/conclusion declarations, and rule specifications can be provided in a text file. Editing and loading the file can accomplish configuring the rules and establishing linkages to the underlying condition generators and model types. Blackboard functionality such as when to post incidents and set statuses can also be included.

Such an analysis platform and engine can be used and reused in different management domains, by adapting the underlying domain model, system element definitions, conditions, and rules to a new underlying management system in a new domain. Illustratively, once adapted to a particular domain model, model types, conditions, and rules can be added, deleted, and modified as desired for customization in a particular implementation, for example, to accommodate the preferences of the system operators.

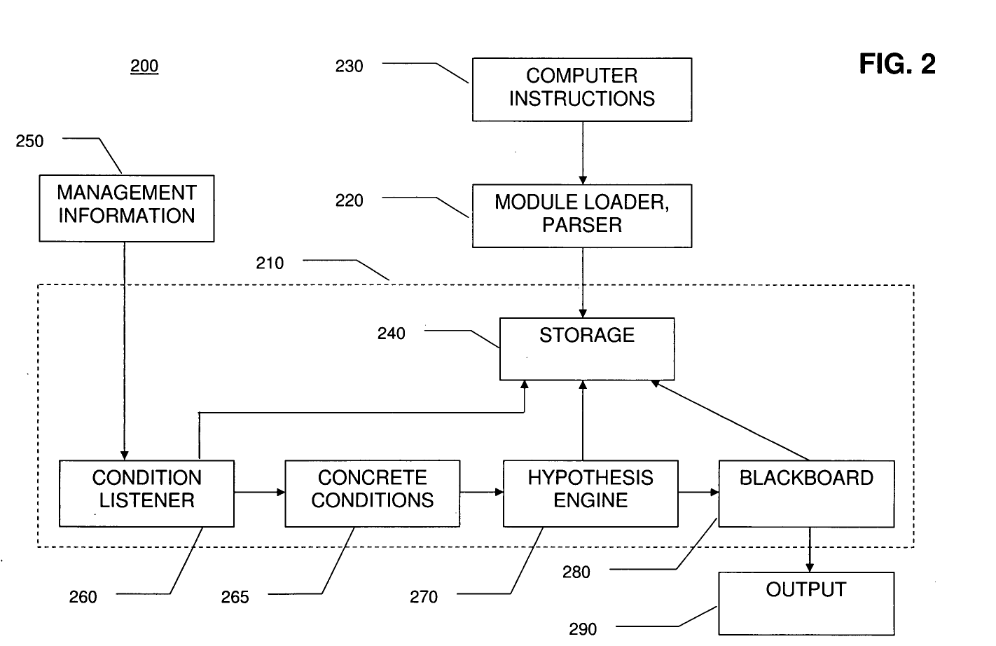

Referring now to FIG. 2, an illustrative causal engine architecture (200) is shown, comprising causal engine (210). The causal engine can be set up by parser and module loader (220), which parses and loads modules containing computer statements (230) into module storage (240). The statements can include model type definitions, declarations of conditions/conclusions, and specifications of rules. In operation, the causal engine (210) receives a stream of information, such as indicators of anomalous conditions on system elements, from a system management application (250). The indicators are received at a condition listener (260). The condition listener consults the loaded modules to determine how to process such indicators, for example, to normalize the received indicators into concrete conditions (265).

The concrete conditions can be provided to hypothesis engine (270). Hypothesis engine (270) can consult module storage (240) and can create one or more hypotheses representing possible causes of the received conditions, and can provide the hypotheses to the blackboard (280). For example, concrete conditions can be matched to the rules that take such conditions as input. As additional indicators are received and new conditions generated, the existing hypotheses are examined to see if they can consume the new conditions. If no existing hypothesis can consume a condition, then one or more new hypotheses can be generated that can consume the condition.

A hypothesis that is confirmed, such as by receiving appropriate confirming management information, can be asserted as a conclusion. A conclusion can be retained by the blackboard (280) which manages the artifacts of the analysis. Illustratively, artifacts of the analysis may include the generated hypotheses, asserted conclusions, posted incidents, the set status of some managed entity, and the like. The blackboard can also hold artifacts for possible suppression, as will be discussed. The blackboard can also perform cancellation of hypotheses, as will be discussed. A conclusion that satisfies all of the received conditions and is not itself caused by another conclusion can be identified as a root cause, and can be provided at output (290).

Illustratively, analysis of the effect of an asserted root cause that combines causal rules with a model-based logic may also be provided. For example, causal engine (210) can be used to determine the effect of the determined root cause on the modeled system, using the loaded model type definitions, conditions declarations, and rules.

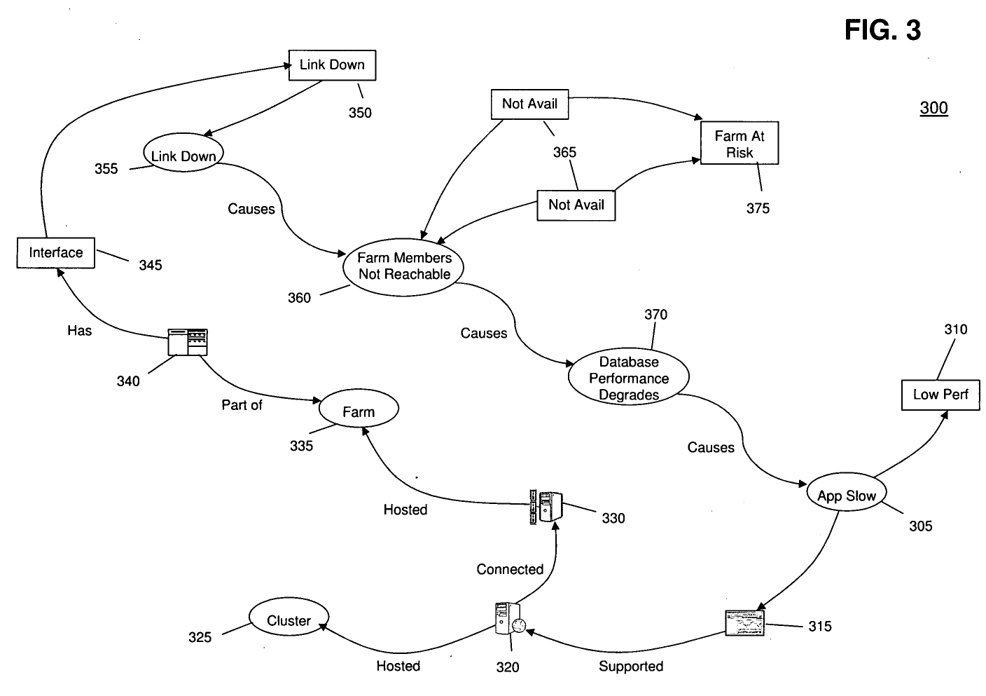

FIG. 3 shows an illustrative causal graph (300) indicating relationships between various system elements experiencing symptoms indicative of a problem on an illustrative modeled system, such as the system of FIG. 1. An analysis engine can receive management information from one or more management applications that monitor the three planes of the exemplary computer network. A first symptom of a problem may be that a web application has slowed down (305). A user of the application may complain to a technician that the application has slowed, and the technician may provide information of the slowdown to the analysis engine. The engine may trigger a management application to confirm the low performance (310). The web application (315, 132) is supported by an application service, such as a web application server (320, 134), that is hosted on a server cluster comprising several servers (325, 124). The web application server is connected to and depends upon one or more instances of a database (330, 136) hosted on a server farm (335, 126). The database may be distributed over several servers (340) that are interconnected via a network switch (115) through network interfaces (345, 119). The analysis engine can hypothesize that the slowness is caused by one or more servers of the server farm being inaccessible, and can trigger the management application to ping the switch (350). In like manner, the root cause of the problem may finally be identified as a link failure (355, 118) between the switch and some of the servers, which has resulted in two of the managed servers in the database farm becoming unreachable (360, 128).

In addition, at approximately the same time the user complained of application slowness, the management system of the database servers may detect that two of the managed servers are unavailable (128) and send indicators of symptoms (365) that indicate the database farm is not fully operational. Furthermore, the performance of the database instance that supports the web application may degrade (370), and the database monitoring application may detect this and send additional performance symptoms (not shown). Finally, the management of the web application (315, 132) may exhibit performance problems in the application and emit indicators regarding the application performance (310) symptoms. Such symptoms are consistent with the determined root cause, and can be assumed to be part of the same episode.

A causal analysis engine can thus be used to quickly determine the root cause of observed problematic symptoms. This approach to root cause analysis combines condition information and model-based logic to provide a fast and effective mechanism for doing such analyses. The complexities of the underlying relationships can be represented and accounted for automatically, and can therefore be filtered from the information presented to the analyst. Furthermore, indicators of anomalous operation can come from any source in the managed environment, enabling analysis across domains. In addition, the indicators can be managed automatically, and can also be filtered or selectively filtered from the information presented to the analyst.

Thus, analysis artifacts can be managed to effectively identify the root cause of observed problematic symptoms while providing an improved user experience, such as by shielding the analyst from the complexity of the analysis. The artifacts can be generated by a root cause analysis platform that employs CPS analysis, such as has been described. However, it is contemplated that treating analysis artifacts by managing them as though they are part of a single episode as will be described can also be applied to other root cause analysis systems as well.

Thus, an important aspect of handling analysis artifacts is how they can be managed to give a preferred customer experience. For example, in a network management domain wherein a major outage has occurred, the root cause might be identified as a failed router in the network core. Intermediate results in the analysis may indicate that devices behind (downstream from) the router are not responsive. In addition, devices connected to the router will report or can be polled to reveal down interfaces. In such a scenario, an exemplary implementation of a root cause analysis system can give an improved user experience by not showing the incidences generated from the downstream devices. However, the status of the downstream devices can still be indicated as unreachable. Artifacts from the down neighbor interfaces can be correlated to the failed router artifact because they are related to that root cause, and those artifacts can also be filtered from being displayed, or can be selectively displayed. In addition, when the router comes back up those artifacts can be canceled and removed from the operator console with the status of the downstream devices changed from unreachable to responding.

Another analysis example is a failed disc on a storage network. In such a case application errors (e.g., database errors) could occur. In order to give an improved operator experience, the disc failure can be identified as the root cause of the application errors, and displayed on the operator console. The application errors themselves can be filtered from being displayed, or can be selectively displayed.

In a system of inter-related elements such as has been described, intermediate analysis results can also be interdependent, and can be generated concurrently or out of order. The intermediate results can also be filtered from being displayed, or can be selectively displayed. For example, an interface down might be a cause of observed problematic symptoms, or it might be associated with the interface being disabled, or it might be the result of another device failure. If the down interface is identified as a root cause, then the interface down artifact can be released as a root cause, and an incident can be generated and displayed on the operator console. Until the root cause is identified, artifacts of the analysis need not be released, but can be filtered from being displayed, or can be selectively displayed.

In an exemplary embodiment, a preferred amount of time can be set within which received events indicating anomalous element operation can be assumed to be related, and managed accordingly. That amount of time defines an “episode,” and the episode is deemed to expire after that amount of time elapses. The artifacts of observed problematic symptoms received before the episode expiration time are assumed to be related to the same problem. In an exemplary embodiment, the time period of the episode can be selected as a time period within which all newly received observed problematic symptoms will be deemed related. For example, the time when the first received problematic symptom is received can set a window or timer, such as two minutes, fifteen minutes, or any other preferred time period within which observed problematic symptoms may be deemed related. The window can be based on one or more characteristics of the received observed problematic symptoms. For example, an episode duration of two minutes can be set based on a received symptom indicating an interface is down; or an episode duration of fifteen minutes can be set based on a node down received symptom. All observed problematic symptoms received within the episode duration can be managed as part of the same episode.

In another exemplary embodiment, the time period between received indicators of observed problematic symptoms can be selected to determine the duration of an episode, such as one minute between received indicators, or two minutes, or the like. In this embodiment, if an observed problematic symptom indicator is received before the selected time period elapses since the previous indicator was received, the newly received symptom can be deemed to be related to the previously received symptom and treated as part of the same episode.

In either embodiment, illustratively, if a network node goes down, then for some amount of time after it goes down its neighbor devices will report connection problems. After that time period elapses, new connection problems on neighbor device interfaces will no longer be considered as part of the same episode as the node failure. That is because other, unrelated problems can occur on the neighbor devices that are not part of the same episode.

When indicators of anomalous element operation are received, a root cause analysis can be initiated. The analysis can generate hypotheses which are representative of possible true root causes of the observed problematic symptoms. The analysis generates the hypotheses based on the observed problematic symptoms. That is, hypotheses are generated that can satisfy one or more of the observed problematic symptoms.

A hypothesis can be confirmed, such as by polling system elements related to the hypothesis to determine if the elements are behaving as they would be if the hypothesis were correct. If so, the hypothesis can be asserted as a conclusion. However, generating a conclusion does not necessarily indicate that the root cause of the observed problematic symptoms has been identified, because the conclusion could itself have been caused by another problem. If a conclusion is caused by a further problem, the conclusion is referred to as secondary cause, and not a root cause. A conclusion is identified as a root cause only when it is determined that it is not a secondary cause.

The analysis can retain generated hypotheses for at least the time period of the episode during which they were generated. Additional indicators of anomalous element operation can be received during the time period of the episode, and more hypotheses can be generated based on the received indicators. The hypotheses can be confirmed by receiving consistent information from a management application, or by polling system elements for related information, as described previously. If an indicator is received that is inconsistent with an unconfirmed hypothesis, the unconfirmed hypothesis can be canceled. For example, a node up indicator from a node can cancel a previously generated node down hypothesis. Preferably, at the end of the episode, that is, at the expiration of the time period that defines the episode, the hypotheses that have been confirmed can be asserted as conclusions, and the rest can be discarded. The conclusions can then be collated, and secondary conclusions can be identified. The root cause can be identified as a conclusion that is not secondary. The identified root cause can be output to an operator console.

Furthermore, an indicator may have value to an analyst or system operator under certain circumstances, but may not have value under other circumstances. An indicator that does not have value can be deemed superfluous. If desired, a superfluous indicator can be suppressed, that is, treated as though it had not been received. An indicator can be pre-defined to be selectively suppressed if an appropriate related indicator is received or an appropriate conclusion is asserted. For example, an address down indicator may or may not add value, depending on the circumstances. If the associated node is down, an operator will typically only want to know that the node is down, but doesn't care specifically about the address being down. Thus, an address-down indicator can be pre-defined to be suppressed if the associated node is down, depending on operator preference. However, unlike an address down, typically an interface down or connection down would not be suppressed. That is because operators generally want incidences generated for them, for example, to keep track of their reliability, or to trigger automatic actions (such as issuing a page).

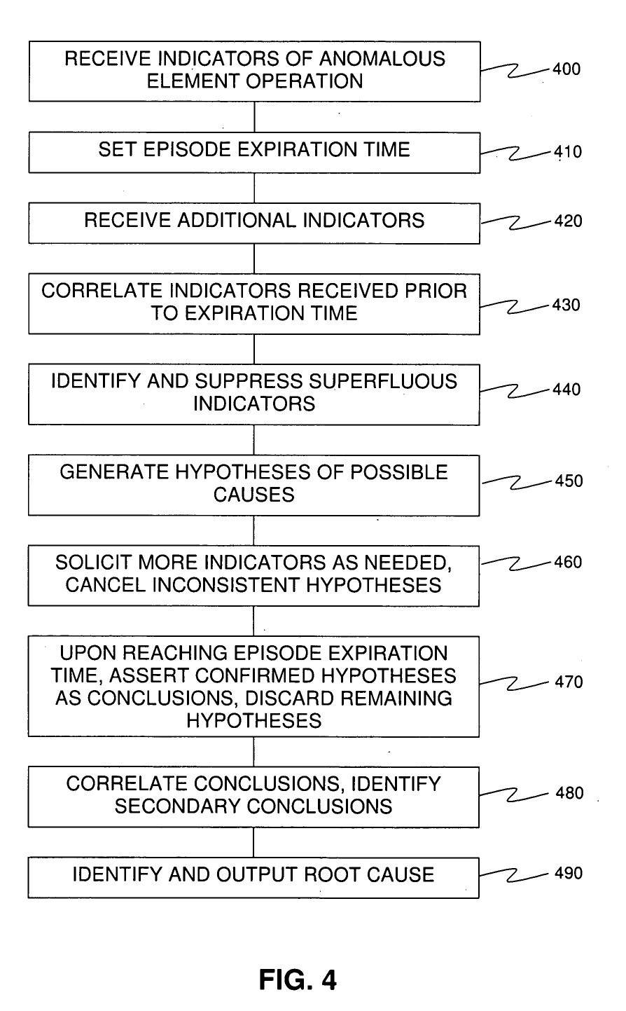

Referring now to FIG. 4, shown is a flow chart illustrating a root cause analysis method. The method begins when one or more indicators of anomalous system element operation are received (400). Based on the indicators received, an episode expiration time can be set (410). The episode expiration time can be set based on a pre-defined episode duration, that can be pre-defined to be any value, such as a value preferred by a party such as a system operator, and as such may be based on the operator's experience. For example, an episode duration of fifteen minutes can be pre-defined for a node down. If an indication is then received that a node is down, an episode expiration time can be set that is fifteen minutes after the time of the node down indication. Different episode durations can be set for anomalous operation of different types of elements. For example, a two-minute episode duration may be pre-defined for an address down. Then, if an indication is received that an address is down, an episode expiration time can be set that is two minutes after the time of the address down indication, based for example on the time the address down indication is received, or the time it was sent. The address down episode can be superseded by a subsequently received indication that the node associated with that address is down, with a corresponding episode expiration time set based on a fifteen-minute episode. Node down and address down events of fifteen minutes and two minutes, respectively, are used as examples only. Any type of element can have its own episode duration pre-defined, and that duration can be pre-defined to be any desired value.

Additional indicators may be received before the episode expiration time (420). Indicators received prior to the episode expiration time are deemed to be part of the same episode. Upon or after reaching the episode expiration time, the received indicators can be correlated (430). The indicators can be correlated based on pre-defined relationships between the system elements and/or conditions, as previously described. Superfluous indicators can also be identified and suppressed (440), as previously described.

Hypotheses of possible causes of the received indicators can be generated (450), consistent with the received indicators and with pre-defined causal relationships between elements and/or conditions. The indicators received may not be sufficient to confirm whether a hypothesis represents an actual cause of received indicators. Additional indicators can be solicited as needed to confirm which hypotheses represent actual causes (460). A newly received indicator may be inconsistent with an already generated hypothesis. If so, that hypothesis can be canceled, because it is no longer consistent with the received indicators. New hypotheses can also be generated based on the solicited indicators. Additional indicators can be solicited as needed to confirm which of those hypotheses represent actual causes, and so on.

Upon reaching the episode expiration time, the hypotheses that are confirmed can be asserted as conclusions, and the remaining hypotheses can be discarded (470).

A conclusion thus represents an anomalous element state or status that has been confirmed, and it is that confirmed state or status that has caused the associated received indicators to be sent. As previously described, an anomalous state in a first element (and thus its associated conclusion) may also have caused an anomalous state in a related second element. If so, the conclusion based on the first element is referred to as a primary cause, and the conclusion based on the second element is referred to as a secondary cause. However, that primary cause may itself have been caused by an anomalous state on yet another element. If so, that primary cause is itself secondary to yet another primary cause, and so on. The conclusions can be correlated based on the relationships between their respective elements, and the secondary causes can be identified (480). A conclusion that is a primary cause and not also a secondary cause is deemed to be identified as a root cause of the received indicators, and can be output as the root cause (490), for example, by displaying on an operator console.

A computer readable medium may also be provided for use in performing root cause analysis in a system comprising a plurality of inter-related elements wherein at least some of the elements experience one or more anomalous conditions, the computer readable medium comprising computer-readable instructions to cause a processor to perform one or more of the processes described herein, such as to receive one or more initial indicators of system element states symptomatic of anomalous element operation; select an episode expiration time based on the received initial indicators; receive additional indicators of system element states symptomatic of anomalous element operation; correlate the indicators received prior to the episode expiration time based on pre-defined relationships between the system elements; generate one or more possible causes of the anomalous element states consistent with the received indicators and the pre-defined relationships; assert one or more of the possible causes as one or more actual causes; identify one of the actual causes as a root cause; and/or output the root cause.

An apparatus may also be provided for managing artifacts of a root cause analysis of a system comprising a plurality of inter-related elements, wherein at least some of the elements experience one or more anomalous conditions, the apparatus comprising one or more of an input for receiving of possible causes of anomalous element states as hypotheses; a processor for analyzing and correlating the hypotheses and identifying a root cause of the anomalous element states; storage for storing artifacts of the analysis including the hypotheses; a computer-readable medium comprising descriptions of at least a portion of the elements of the system, including conditions symptomatic of anomalous element operation, descriptions of relationships between at least a portion of the described elements and the conditions, and instructions for causing the processor to process the hypotheses using the conditions and relationships, and to identify at least one root cause consistent with the conditions and relationships; and an output for outputting the identified root cause.

Various modifications and variations can be made to the disclosed system without departing from the spirit or scope of the invention. Thus, it is intended that the appended claims cover the modifications and variations of the disclosed system provided they come within the scope of the claims and their equivalents.

1. A method of managing artifacts of a root cause analysis and outputting an identified root cause, for use in a system comprising a plurality of inter-related elements, wherein at least some of the elements experience one or more anomalous states, the method comprising:
receiving one or more initial indicators of system element states symptomatic of anomalous element operation;
selecting an episode expiration time based on the received initial indicators;
receiving additional indicators of system element states symptomatic of anomalous element operation;
correlating the indicators received prior to the episode expiration time based at least in part on pre-defined relationships between the system elements;
generating one or more possible causes of the anomalous element states consistent with the received indicators and the pre-defined relationships;
asserting one or more of the possible causes as one or more actual causes;
identifying at least one of the actual causes as a root cause; and
outputting the root cause.

2. The method of claim 1, further comprising, before the step of identifying the root cause, soliciting one or more indicators from one or more system elements.

3. The method of claim 1, further comprising:
pre-defining one or more selected indicators as superfluous when received during an episode with one or more other pre-determined indicators;
identifying one or more of the received indicators as superfluous, and
suppressing the superfluous indicators.

4. The method of claim 1, wherein the expiration time is selected based on an element type of an element from which an initial indicator was received.

5. The method of claim 1 further comprising:
retaining all of the generated possible causes until the episode expiration time is reached;
asserting the actual causes upon reaching the episode expiration time; and
thereafter discarding the possible causes that were not asserted.

6. The method of claim 5, further comprising:
correlating the actual causes and identifying one or more of the actual causes as secondary causes based at least in part on pre-defined relationships between the system elements affected by the actual causes; and
identifying the root cause as an actual cause that is not a secondary cause.

7. The method of claim 1, further comprising:
canceling one or more of the possible causes based on one or more actual causes that are inconsistent with the possible causes being canceled.

8. A computer readable medium for use in performing root cause analysis in a system comprising a plurality of inter-related elements wherein at least some of the elements experience one or more anomalous conditions, the computer readable medium comprising computer-readable instructions to cause a processor to:
receive one or more initial indicators of system element states symptomatic of anomalous element operation;
select an episode expiration time based on the received initial indicators;
receive additional indicators of system element states symptomatic of anomalous element operation;
correlate the indicators received prior to the episode expiration time based on pre-defined relationships between the system elements;
generate one or more possible causes of the anomalous element states consistent with the received indicators and the pre-defined relationships;
assert one or more of the possible causes as one or more actual causes;
identify one of the actual causes as a root cause; and
output the root cause.

9. An apparatus for managing artifacts of a root cause analysis of a system comprising a plurality of inter-related elements, wherein at least some of the elements experience one or more anomalous conditions, the apparatus comprising:
an input for receiving of possible causes of anomalous element states as hypotheses;
a processor for analyzing and correlating the hypotheses and identifying a root cause of the anomalous element states;
storage for storing artifacts of the analysis including the hypotheses;
a computer-readable medium comprising:
descriptions of at least a portion of the elements of the system, including conditions symptomatic of anomalous element operation,
descriptions of relationships between at least a portion of the described elements and the conditions, and
instructions for causing the processor to process the hypotheses using the conditions and relationships, and to identify at least one root cause consistent with the conditions and relationships; and
an output for outputting the identified root cause.
